(19) United States
(12) Patent Application Publication
(10) Pub. No.: US 2026/0234054 A1
(43) Pub. Date: Aug. 13, 2026

(54) NOVEL LADLE SLAG-BASED COMPOSITION

(71) Applicant: KERAKOLL S.P.A., Sassuolo (Modena) (IT)

(72) Inventors: Cristina Barbieri, Sassuolo (Modena) (IT); Vincenzo Liuzzi, Sassuolo (Modena) (IT); Alberto Spaggiari, Sassuolo (Modena) (IT)

(73) Assignee: KERAKOLL S.P.A., Sassuolo (Modena) (IT)

(21) Appl. No.: 19/470,830

(22) PCT Filed: Mar. 29, 2024
(86) PCT No.: PCT/IB2024/053102

§ 371 Date: Sep. 30, 2025

(30) Foreign Application Priority Data
Mar. 30, 2023 (EP) 23165449.2

(51) Int. Cl. C04B 7/153; C04B 24/06; C04B 28/08; C04B 28/14

(52) U.S. Cl. CPC C04B 7/1535; C04B 24/06; C04B 28/082; C04B 28/14

(57) ABSTRACT

The present invention relates to a composition usable as a binder for premixed cement-based products and/or as an additive for a cement, comprising ladle slag, calcium sulphate, at least one soluble sulphate having a solubility in water at 20° C. in the range of 5 g/100 mL to 90 g/100 mL, and at least one carboxylic acid that has at least two carboxyl groups, wherein the percentage by weight of the at least one soluble sulphate is between 0.3 and 10% relative to the total weight of the composition, the percentage ratio between calcium sulphate and ladle slag ranges from 1:2 to 1:6, preferably from 1:3 to 1:4, and wherein the carboxylic acid is present in an amount of between 0.05% and 3% by weight relative to the total weight of the composition, preferably between 0.17% and 1.5%. The invention relates to the use of the composition of the invention as a binder for a premixed cement-based product and/or as an additive for a cement, and the premixed cement-based products and cements which contain it. The invention also relates to a cement-based conglomerate obtained from the premixed cement-based product of the invention, once hardened.

### TECHNICAL FIELD

The present invention relates to a composition usable as a binder for a premixed cement-based product and/or as an additive for a cement, comprising ladle slag, calcium sulphate, at least one soluble sulphate and at least one carboxylic acid that has at least two carboxyl groups, wherein the carboxylic acid is present in an amount of between 0.05% and 3% by weight relative to the total weight of the composition, preferably between 0.17% and 1.5%.

### STATE OF THE ART

Metallurgical processes for cast iron and steel production generate substantial amounts of slag, whose composition is closely related to the characteristics of the raw materials and the additives used in the process. Part of this steel slag is initially accumulated in steelmaking plants and possibly sent to waste disposal sites, whereas part of it is used in civil engineering applications, thus alleviating the needs tied to its disposal and reducing the use of natural resources.

Depending on whether the slag derives from metallurgical processes in a blast furnace, oxygen converter, electric arc furnace, ladle furnace for refinement and so on, the slag will have different physicochemical characteristics and will take its name based on the furnaces it is generated in.

Metallurgical slag is classified on the basis of the legislation currently in force, such as, for example Regulation (EC) No 1907/2006 concerning the Registration, Evaluation, Authorisation and Restriction of Chemicals (REACH), according to such physicochemical characteristics.

For every type of metallurgical slag, the REACH Ferrous Slag Consortium (RFSC), scientifically guided by the German Research Institute for Iron and Steel Slags (FEhS), has thus defined the qualitative and quantitative parameters of the substance as is and of its eluate, so as to achieve a unique characterisation of slag, based on which the studies required under the REACH Regulation have been developed.

The granulated slag generated by blast furnaces is called “granulated blast furnace slag” (GBS, CAS number 65996-69-2, EINECS number 266-002-0) or “air-cooled blast furnace slag” (ABS, CAS number 65996-69-2, EINECS number 266-002-0); the slag generated by converters is called “basic oxygen furnace slag” (BOFS, CAS number 91722-09-7, EINECS number 294-409-3); the slag obtained from electric furnaces is called “electric arc furnace slag from carbon steel production” (EAF-C, undefined CAS number, EINECS number 932-275-6) or “electric arc furnace slag from stainless/high alloy steel production” (EAF-S, undefined CAS number, EINECS number 932-476-9); finally, the slag obtained from secondary metallurgy, which makes it possible to arrive at the finished product starting from recycled scrap material, is called “steelmaking slag” (SMS, CAS number 65996-71-6, EINECS number 266-004-1).

Some types of slag are commonly used as raw materials for the construction industry and are therefore recognised as a by-product. For example, blast furnace slags (GBS and ABS) have always been used in the production of blast furnace slag cement according to standard UNI EN 197-1, whereas electric arc furnace slags from carbon steel production (EAF-C) are commonly used as a replacement for natural aggregates in civil engineering works and road construction. In both of the above-mentioned cases, the use of slags reduces the consumption of natural resources and avoids the landfill disposal thereof.

Other types of slag, in particular steelmaking slag (SMS), is more difficult to place on the market as a by-product and is very often considered as waste to be disposed of, thus constituting a serious problem from both an environmental and a logistical viewpoint. With reference to 2021, the production of steelmaking slag in Italy was quantified as over 500,000 tonnes and it is estimated that over 80% was sent as waste to landfills. Steelmaking slag—Registration Dossier—ECHA (europa.eu)—or ladle slag derives from secondary processing of steel obtained with the EAF process (I. Z. Yildrim et al., “Chemical, Mineralogical, and Morphological Properties of Steel Slag”, Advances in Civil Engineering (2011), ID463638, DOI: 10.1155/2011/463638). It is also referred to as “secondary slag” or “reduction slag”, because it is obtained from a secondary metallurgical reduction process (S. Choi et al., “Hydration reactivity of calcium-aluminate-based ladle furnace slag powder according to various cooling conditions”, Cement and Concrete Composites (2020) vol. 114, 103734, https://doi.org/10.1016/j.cemconcomp.2020.103734).

In jargon, moreover, the slag deriving from an electric arc furnace (EAF) is defined as “black slag”, whilst the slag deriving from the steel refinement phase outside that furnace (secondary process), which takes place in a ladle furnace (ladle slag), is in turn defined as “white slag”. In the secondary steelmaking process, the reduction of iron oxide into actual steel takes place and the slag that is generated is less contaminated than black slag. As already indicated above, the two types of slag have a different analytic and product composition.

One of the problems that makes it difficult to use ladle slag, which is characterised by a low iron oxide content and high calcium oxide and alumina content, is the fact that once cooled to room temperature it forms therewithin free crystalline oxides, such as, for example, calcium oxide, magnesium oxide and iron oxide. Said oxides can subsequently react with the water for mixing cement-based mixtures in which pulverised electric arc furnace slag is used, thus producing calcium, magnesium and iron hydroxides, which act as expansive substances, ruining the cement-based materials that contain them (J.-M. Kim et al., Construction and Building Materials (2016) vol. 127, p. 93-101). Furthermore, the transformation of the crystalline lattice that occurs during cooling leads to the formation of a fine powdery material, which considerably complicates the environmental and logistical management thereof.

Numerous systems and processes have been proposed to resolve the above-mentioned problems, with the aim of simplifying the management of ladle slag in a manner that is safe from an environmental viewpoint and sustainable from an economic viewpoint and transforming it into a product that can be reused in other fields of application.

As in the case of blast furnace slag, these processes include granulation with water or dry granulation of slag in the liquid state. In this manner, the ladle slag is cooled abruptly and transformed into granules with a vitreous or crystalline structure, thus acquiring hydraulic characteristics.

Dry granulation, as described for example in document WO2021156789A1 in the name of Tenova Spa, is preferable, where possible, to that with water, since it avoids the consumption of water and reduces water treatment needs.

Ladle slag, rich in calcium aluminate and aluminium oxide, is already reactive on its own: in the presence of water, it becomes hydrated, giving rise to a cementitious phase. However, these reaction products are metastable.

The addition of gypsum to decrease the reactivity of calcium aluminate is known: in fact, hydration between gypsum and calcium aluminate can lead to ettringite formation.

The use of carboxylic acids in compositions usable in the building industry is also known, in particular with a specific action as setting retarders and, at times, as fluidisers.

Setting retarders increase the workability time of the mixed product and also increase the time of the plastic phase thereof. This action is often also accompanied by one of slowing down hardening; given an equal curing of the test sample (above all in the short term), the mechanical strengths recorded with the addition of acid are lower than those of the reference system without.

Fluidisers can decrease the mix ratio (water:binder) necessary for the formulation. Decreasing the water in the mixture usually increases mechanical strength by producing a more compact matrix.

However, though carboxylic acids can have a fluidising action, the retarding function remains prevalent. In fact, the class of additives known as fluidisers has evolved and contains within it prevalently high molecular weight functionalised polymers. The latter decrease the mix ratio without modifying the setting and hardening times of the binder.

There is thus a felt need for hydraulic binding mixtures comprising steel slags, usable as additives for premixed cement-based products, and which allow the disadvantages of the prior art to be overcome.

### Definitions

Unless otherwise defined, all the terms of the art, notations and other scientific terms used herein are intended to have the meanings commonly understood by those who are skilled in the art to which this description pertains. In some cases, terms with commonly understood meanings are defined herein for the sake of clarity and/or for ease of reference; the inclusion of such definitions in the present description should thus not be interpreted as representing a substantial difference from what is generally understood in the art.

The terms “comprising”, “having”, “including” and “containing” are to be understood as open-ended terms (i.e. the meaning of “comprising, but not limited to”) and are to be considered as a support also for terms like “consist essentially of”, “consisting essentially of”, “consist of” or “consisting of”.

For all the intervals indicated in the text, figures and claims of the present patent application, it is understood that the endpoints of these intervals are included.

The terms “obtainable”, “obtained”, “obtainable directly from”, “obtained directly from” are considered equivalent.

“Premixed cement-based product” means any product consisting of binders, inert substances and additives, adapted to harden once mixed with water. Such products can have a wide variety of applications in the building industry, from tiling to concrete restoration, to interior decoration. “Ladle slag” means a slag rich in aluminium and calcium and with a low content of iron oxides. Said ladle slag originates from the secondary refinement process for steel produced by means of electric arc furnaces. In the secondary process, one observes a reduction of the iron oxide in steel.

According to a preferred aspect, the ladle slag used in the present invention is subjected to a deferrization process prior to its use.

In one embodiment, the deferrized ladle slag used in the present invention is obtained with the process described in international patent application WO2021156789A1 in the name of Tenova Spa (hereinafter referred to as “the “Tenova process”).

According to another preferred aspect, the deferrized ladle slag used in the present invention, preferably obtained with the Tenova process, comprises:
aluminium oxide (Al₂O₃) 20-40%;
calcium oxide (CaO) 45%-65%.

Any remaining part to 100% comprises at least one of the following oxides:
silicon dioxide (SiO₂), present in a maximum amount of 12-14%;
magnesium oxide (MgO), present in a maximum amount of 10-15%
ferric oxide (Fe₂O₃), present in a maximum amount of 3-5%;
sodium oxide (Na₂O), present in a maximum amount of 1-2%;
potassium oxide (K₂O), present in a maximum amount of 1-2%;
titanium dioxide (TiO₂), present in a maximum amount of 0.3-1%;
barium oxide (BaO), present in a maximum amount of 0.1-0.5%;
phosphorous pentoxide (P₂O₅), present in a maximum amount of 0.3-1%;
sulphur trioxide (SO₃), present in a maximum amount of 3-4%,
   wherein all the percentages are by weight relative to the total weight of the ladle slag.

In one embodiment, the ladle slag comprises:
aluminium oxide (Al₂O₃) 20-40%;
calcium oxide (CaO) 45%-65%;
magnesium oxide (MgO) 5-10%,
silicon dioxide (SiO₂) 8-10%
   the remaining part to 100% consisting of other oxides present in trace amounts.

Preferably, the ladle slag is at least 90% in amorphous form, more preferably at least 94%, whilst the remaining part may be crystalline. The crystalline phase preferably comprises periclase, celite, mayenite, quartz and/or crystalline calcium oxide.

In a particularly preferred embodiment, the ladle slag is 100% in amorphous form.

The term “anhydrite” indicates anhydrous calcium sulphate.

The term “gypsum” indicates calcium sulphate dihydrate.

The term “scagliola” indicates calcium sulphate hemihydrate.

The term “ettringite” indicates the compound that forms due to the reaction between calcium aluminate and calcium sulphate in the presence of water.

The terms “setting” and “setting time” are synonymous and refer to the time necessary in order for the fresh product to reach a hardened state, after which time the behaviour changes from plastic to fragile.

The term “pot life” means the time in which the product preserves intact its rheological and workability characteristics in the fresh state.

“Hardening time” means the time in which mechanical strength grows once the product has hardened.

“Soluble sulphate” means a sulphate having a solubility measured in water at 20° C. in the range of 5 g/100 mL to 90 g/100 mL, preferably selected from an alkaline sulphate, an alkaline earth sulphate, with the exception of calcium sulphate and strontium sulphate, and with the exception of radioactive alkaline or alkaline earth sulphates (sixth and seventh periods). It also means aluminium sulphate. Preferably, the soluble sulphate is selected from potassium sulphate, sodium sulphate, lithium sulphate, magnesium sulphate, and aluminium sulphate. Even more preferably, the soluble sulphate is potassium sulphate.

| | Calcium | Calcium | | | | | |
|---|---|---|---|---|---|---|---|
| Sulphate | (dihydrate) | (anhydrous) | Sodium | Potassium | Lithium | Magnesium | Aluminium |
| Solubility | 0.26 | 0.2 | 28.1 | 12 | 34.9 | 30 | 36.4 |
| in g/100 | | | | | | | |
| mL of | | | | | | | |
| water | | | | | | | |
| T | 25 | 20 | 25 | 25 | 25 | 20 | 20 |
| solubility | | | | | | | |
| in Celsius | | | | | | | |

“Carboxylic acid” means an acid that has at least two carboxyl groups (an at least dicarboxylic acid), preferably a dicarboxylic acid that has a hydroxyl group in the a position relative to the carboxyl group (alpha-hydroxy acid (AHA)). Preferably, the carboxylic acid is selected from tartaric acid, malic acid, citric acid, lactic acid, succinic acid, oxalic acid and/or malonic acid. The salts of said carboxylic acid, such as, for example the sodium salt or potassium salt, can also be used.

Polymeric carboxylic acids are excluded from the definition of a carboxylic acid with at least two carboxyl groups.

Development of “short-term mechanical strength” means the development of mechanical strength within 24 hours after the start of mixing of the binding composition with water.

The abbreviation “CS” means compressive strength.

### BRIEF DESCRIPTION OF THE FIGURES

FIG. 1 contains table 1, relating to example 1, in which one can see the experimental results supporting the regulatory capacity of potassium sulphate with respect to ettringite formation in conglomerates obtained with a composition according to the invention.

FIG. 2 contains table 8, relating to example 6, in which one can see the experimental results supporting the capacity of tartaric acid to accelerate the formation of primary ettringite.

FIGS. 3-7 contain, respectively, tables 12A (potassium sulphate), 12B (sodium sulphate), 12C (lithium sulphate), 12D (magnesium sulphate) and 12E (aluminium sulphate), relating to example 9, in which one can see the experimental results supporting the capacity of soluble sulphates to regulate ettringite formation in conglomerates obtained with a composition according to the invention.

FIGS. 8-10 contain, respectively, tables 14A (tartaric acid), 14B (citric acid) and 14C (malic acid), relating to example 10, in which one can see the experimental results supporting the capacity of carboxylic acids with at least two carboxyl groups to accelerate the formation of primary ettringite and to increase the short-term mechanical strength of conglomerates obtained with a composition according to the invention.

### SUMMARY OF THE INVENTION

The present invention relates to a composition usable as a binder for a premixed cement-based product or as an additive for a cement, comprising ladle slag, calcium sulphate, at least one soluble sulphate having a solubility measured in water at 20° C. in the range of 5 g/100 mL to 90 g/100 mL, preferably selected from an alkaline sulphate, an alkaline earth sulphate, with the exception of radioactive alkaline or alkaline earth sulphates, and aluminium sulphate and at least one carboxylic acid that has at least two carboxylic groups, wherein the percentage by weight of the at least one soluble sulphate is between 0.3 and 10% relative to the total weight of the composition, the percentage ratio between calcium sulphate and ladle slag ranges between 1:2 and 1:6, preferably between 1:3 and 1:4, and wherein carboxylic acid is present in an amount of between 0.05% and 3% by weight relative to the total weight of the composition, preferably between 0.17% and 1.5%.

The invention relates to the use of the composition of the invention as a binder for a premixed cement-based product and/or as an additive for a cement.

Said cement containing the additive can be used in a premixed cement-based product.

The invention also relates to a premixed cement-based product comprising said composition, aggregates and water or a premixed cement-based product to be hydrated comprising said composition and aggregates. The object of the present invention also relates to a cement-based conglomerate obtained from the premixed cement-based product of the invention, once hardened.

Furthermore, the invention relates to a cement comprising the composition of the invention.

### DETAILED DESCRIPTION OF THE INVENTION

The present invention relates to a composition comprising ladle slag, calcium sulphate, at least one soluble sulphate having a solubility measured in water at 20° C. in the range of 5 g/100 mL to 90 g/100 mL, preferably selected from an alkaline sulphate, an alkaline earth sulphate, with the exception of radioactive alkaline or alkaline earth sulphates, and aluminium sulphate and at least one carboxylic acid that has at least two carboxylic groups, wherein the percentage by weight of the at least one soluble sulphate is between 0.3 and 10% relative to the total weight of the composition, the percentage ratio between calcium sulphate and ladle slag ranges between 1:2 and 1:6, preferably between 1:3 and 1:4, and wherein carboxylic acid is present in an amount of between 0.05% and 3% by weight relative to the total weight of the composition, preferably between 0.17% and 1.5%.

Said composition is used as a binder in premixed cement-based products, as it acts as a rapid expansive binder. Furthermore, it is used as an additive for a cement.

The composition of the invention advantageously permits a rapid development of mechanical strength in the premixed cement-based products and cements to which it is added, once mixed with water and hardened.

Preferably, the composition of the invention comprises ladle slag in a percentage by weight of between 37% and 84.65% relative to the total weight of the composition, even more preferably between 71 and 75%.

According to another preferred aspect, the composition of the invention comprises calcium sulphate in a percentage by weight of between 15% and 50% relative to the total weight of the composition, more preferably in a percentage of between 22 and 24%.

The percentage ratio between calcium sulphate and ladle slag in the composition of the invention ranges from 1:2 to 1:6; it preferably ranges between 1:3 and 1:4. In this manner, one preferably obtains the formation of ettringite as opposed to other hydration products.

Furthermore, according to another preferred aspect, the composition of the invention comprises the at least one soluble sulphate having a solubility measured in water at 20° C. in the range of 5 g/100 mL to 90 g/100 mL, preferably selected from an alkaline sulphate, an alkaline earth sulphate, with the exception of radioactive alkaline or alkaline earth sulphates, and aluminium sulphate, in a percentage by weight between 0.3 and 10% relative to the total weight of the composition, more preferably between 2.7 and 3.5%.

According to another particularly preferred aspect, the composition of the invention comprises the at least one carboxylic acid, which has at least two carboxylic groups, in a percentage by weight of between 0.05% and 3% relative to the total weight of the composition, preferably between 0.17% and 1.5%.

According to a more preferred aspect, the composition of the invention has the following percentage composition by weight:
ladle slag: 37-84.65%;
calcium sulphate: 15-50%;
soluble sulphate: 0.3-10%;
carboxylic acid: 0.05-3%.

According to a further preferred aspect, the composition of the invention has the following percentage composition by weight:
ladle slag: 71-75%;
calcium sulphate: 22-24%;
soluble sulphate: 2.7-3.5%;
carboxylic acid: 0.3-0.7%.

Preferably, the calcium sulphate used in the composition of the invention is selected from anhydrite, gypsum and scagliola. Even more preferably, the calcium sulphate used is in the form of anhydrite.

According to a preferred aspect, the at least one soluble sulphate having a solubility measured in water at 20° C. in the range of 5 g/100 mL to 90 g/100 mL is selected from an alkaline sulphate, an alkaline earth sulphate, with the exception of radioactive alkaline or alkaline earth sulphates, and aluminium sulphate; it is preferably selected from potassium sulphate, sodium sulphate, lithium sulphate, magnesium sulphate, and aluminium sulphate; and it is even more preferably potassium sulphate.

According to a further preferred aspect, the carboxylic acid that has at least two carboxyl groups (an at least dicarboxylic acid) and is used in the composition of the invention has a hydroxyl group in the a position relative to the carboxyl group (alpha-hydroxy acid (AHA)). According to a further preferred aspect, the acid of the present invention is selected from tartaric acid, malic acid, citric acid, lactic acid, succinic acid, oxalic acid and/or malonic acid. The most preferred acid is tartaric acid. The salts of the carboxylic acids indicated above, such as, for example the sodium or potassium salts of said acids, can also be used.

Ladle slag, consisting mainly of amorphous calcium aluminate, possesses a hydraulic activity that manifests itself in rapid, strongly exothermic reactions when it is placed in contact with water. The slag's reactivity can also depend on its degree of fineness (Blaine), as indicated in the experimental part. At higher Blaine values, i.e. with a larger surface area, the slag is more reactive.

According to a preferred aspect, the ladle slag used in the present invention has Blaine fineness values of between 2,000 and 11,000 cm²/g, even more preferably between 3,000 and 6,000 cm²/g.

In order to decrease the high exothermicity of ladle slag, calcium sulphate is then added, which is useful for regulating setting, pot life and hardening time.

From the reaction between the calcium sulphate and calcium aluminate of the ladle slag in the presence of water one obtains ettringite, a mineral of an expansive type which determines the anti-shrinkage/expansive function of the composition of the invention when used in premixed cement-based products with water. In fact, it is desirable to avoid having shrinkages of the material during the curing of conglomerates in order not to impair their performance.

Ettringite generally forms in two moments: at the start of mixing of a binding composition with water (primary ettringite) and in a second moment (secondary ettringite), when the binder has by now hardened. The formation of secondary ettringite introduces states of tension within the system, as secondary ettringite has its own volume and the system could also end up being broken, with a decrease in mechanical performance. Therefore, it is preferable to avoid the formation of secondary ettringite.

In the composition of the invention, the at least one soluble sulphate having a solubility measured in water at 20° C. in the range of 5 g/100 mL to 90 g/100 mL, preferably selected from an alkaline sulphate, an alkaline earth sulphate, with the exception of radioactive alkaline or alkaline earth sulphates, and aluminium sulphate, more preferably selected from potassium sulphate, sodium sulphate, lithium sulphate, magnesium sulphate, and aluminium sulphate, and even more preferably being potassium sulphate, regulates the rate of formation of ettringite both in the short term and in the long term, because it prevents there from being a continuous reaction between the calcium sulphate, preferably anhydrite, and the ladle slag. In fact, as it has a higher solubility in water than calcium sulphate, soluble sulphate makes a concentration of sulphate ions more rapidly available for the slag, which increases its initial reactivity, thus accelerating ettringite formation. In this manner, calcium sulphate, in the presence of water, reacts with the calcium aluminate present in the ladle slag with a given timing so as to quantitively form primary ettringite and avoid the formation of secondary ettringite.

In other words, the soluble sulphate allows ettringite to form only when the elastic modulus of the binding system is still low: in this manner, also in the presence of an expansion due to ettringite, it will not introduce mechanical tensions such as to overcome the physical resistance of the system under tensile stress.

According to a preferred aspect, when the composition of the invention is mixed with water and in a premixed cement-based product or in a cement, the production of ettringite is observed mainly in the first 24 hours after the start of mixing. According to a more preferred aspect, the production of ettringite is observed only in the first 6 hours after the start of mixing

In the binding composition of the invention, the carboxylic acid that has at least two carboxyl groups performs the known function of slowing down setting times, something that is generally also accompanied by a delay in the development of short-term mechanical strength. However, unexpectedly, in the composition of the invention the increase in the times is not accompanied by a deterioration in the short-term mechanical strength, as normally occurs. On the contrary, when carboxylic acid is present in an amount of between 0.05% and 3% by weight of the total weight of the composition, preferably between 0.17% and 1.5%, one obtains an increase in the short-term mechanical strength of the cement-based conglomerate or in the cement containing the additive which is obtained, as demonstrated in the experimental part.

Furthermore, the presence of carboxylic acid that has at least two carboxyl groups, in an amount of between 0.05% and 3% by weight relative to the total weight of a composition according to the invention, preferably between 0.17% and 1.5%, advantageously leads to an acceleration in the rate of formation of primary ettringite, as demonstrated in the experimental part.

The premixed cement-based product of the invention comprises a composition according to the invention together with (inert) aggregates, said aggregates being selected in the group consisting of: stones, artificial aggregates, sand, endogenous rocks, exogenous rocks, expanded clay, glass, or a combination thereof.

The invention further relates to a premixed cement-based product comprising the composition of the invention, (inert) aggregates selected from stones, artificial aggregates, sand, endogenous rocks, exogenous rocks, expanded clay, glass, or a combination thereof, and water.

According to a preferred aspect, the aggregates are present in the premixed cement-based product in an amount of between 40% and 85% w/w (relative to the weight of the dry mixture).

The premixed cement-based product comprising the composition according to any one of the above-described embodiments and aggregates, likewise as described above, must be hydrated at the time of use. According to a preferred aspect, water is added to the premixed cement-based product to be hydrated in an amount of between 12% and 50% w/w (relative to the weight of the dry mixture).

The object of the present invention also relates to a cement-based conglomerate obtained from the premixed cement-based product of the invention, once hardened.

Finally, the present invention relates to the use of a composition as claimed, as a binder for a premixed cement-based product and/or as an additive for a cement.

According to a preferred embodiment, the claimed composition is added to a cement falling within the definitions of CEM 1 to CEM V of standard UNI EN 197-1 2001.

The invention thus also relates to the cement comprising the claimed composition, preferably the cement falling within the definitions of CEM 1 to CEM V of standard UNI EN 197-1 2001 and comprising the claimed composition.

According to a preferred aspect, the claimed composition is present in the cement, preferably a cement falling within the definitions of CEM 1 to CEM V of standard UNI EN 197-1 2001, in a percentage amount in the range of 5% to 50%, preferably in the range of 25% to 45%.

Said cement containing the additive can be used in a premixed cement-based product; therefore, the invention also relates to the use of the cement comprising the claimed composition, as a component in a premixed cement-based product.

The invention is illustrated below by means of experimental examples, which are not to be considered as limiting the scope of the invention.

### EXAMPLES

### Materials and Methods

In the experiments described in the following examples, use was made of a ladle slag according to the invention, having a percentage of amorphous phase of 94.1% and the following percentage composition:

| | |
|---|---|
| SiO₂ (%) | 8.8 |
| Al₂O₃ (%) | 30.0 |
| CaO (%) | 53.3 |
| MgO (%) | 9.7 |
| Fe₂O₃ (%) | 1.2 |
| Na₂O (%) | 0.7 |
| K₂O (%) | <0.1 |
| TiO₂ (%) | 0.2 |
| BaO (%) | <0.1 |
| P₂O₅ (%) | 0.1 |
| SO₃ (%) | 2.3 |

### Preparation of Pure Paste Samples for XRD/TGA Analysis

In this case, the test samples consist only of the binder part, without inert components, so that the instrument can better read the mineralogical phases within them.

The raw materials used are all in the solid state and in powder form. After they have been weighed, one proceeds to mix them manually until obtaining a powder system that is as homogeneous as possible.

For each of the binding compositions used in the experimental part, 5 test samples weighing 50 g each were produced; 300 g of material were weighed to produce them.

The necessary water is added to the powder according to an estimated mix ratio of kg of H2O/kg of binder, and an electric mixer was used, care being taken to mix the powder and water evenly for about 2 min of mixing. Finally, they are poured into plastic containers.

The test samples were allowed to cure in a climate chamber with 60% humidity and a temperature of 21° C. and an XRD mineralogical analysis was performed, with corundum as the standard, and a thermogravimetric analysis was performed on some after 6 hours, 24 hours, 7 days, and 28 days after mixing with water in order to quantify the crystalline and amorphous phases within them.

### Preparation of Standard Mortar Samples for Mechanical Strength Testing

In this specific case, the samples always consisted of 30% of the binding phase being studied and 70% of an inert phase consisting of standard sand (https://www.normensand.de/en/products/cen-standard-sand-en-196-1/). Therefore, the percentages shown for the binding phase were recalculated, maintaining the various ratios in order that it would make up 30% of the standard mortar formula.

The raw materials used are all in the solid state and in powder form. After they have been weighed, one proceeds to mix them manually until obtaining a powder system that is as homogeneous as possible.

The actual production of the mixture is carried out with an automatic mechanical mixer, mounted on which there is a stainless steel rotor that exploits a planetary type movement to optimise the mixing of raw materials. Moreover, it works with an established cycle in accordance with the specifications of EN 196-1, EN 196-3:2005 and EN 480-1. The necessary water is added to the powder according to the estimated mix ratio (kg of H₂O×100/kg of powder) or as a ratio (kg of H₂O/kg of binder), inside the stainless steel receptacle suitable for the mixer. This material ensures its resistance during the cycles of use and prevents the bottom of the receptacle from releasing, as a result of wear, impurities that would consequently be incorporated into the mixture. In the first cycle, lasting for one minute and 30 seconds, the rotor works at two different speeds; the speed is lower for the first minute and then doubles in the remaining 30 seconds. At the end of this step, the mixer stops automatically and the mixture undergoes a rest phase lasting for one minute and 30 seconds. Finally, the mixer is started again and, for a period of 60 seconds, the rotor rotates at maximum speed. At the end of the procedure, the mixture should possess a plastic, sufficiently workable consistency. The instrument used in this case is an automatic Matest mixer.

Once the mixture has been produced, it must be placed inside suitable formwork, i.e. moulds in which the material undergoes the setting process and the first phase of hardening, thereby acquiring the characteristic shape of the device itself. Depending on the type of test it is intended to carry out, the moulds have a different shape and size (UNI EN 196-1:2005). They must be made up of three horizontal compartments so as to enable the simultaneous preparation of three test samples; they are made of steel and consist of walls about 10 mm thick. The test samples used for the strength test are cube-shaped, with 40 mm sides.

After the sample is produced, it is placed in a humidity chamber, in which there is a monitored degree of humidity, kept constant in a range of 90-98% and 23° C. The sample is left in the chamber for 24 hours. Then, if the sample has acquired sufficient rigidity, the formwork is disassembled; otherwise, the sample is left inside it for the whole period deemed necessary. In both cases, once the 24 hours have elapsed, the sample is transferred from the humidity chamber to a dry one, in which the constant humidity is 60% and 21° C. The samples are placed inside dry chamber for the whole time necessary for curing them, the period elapsing between their formation and the performance of the test it is intended to carry out. Given that the properties of construction binders vary greatly with the hydration time, tests are performed on each composition at different fixed curing times. The curing period thus depends on when it is desired to perform the test.

### Evaluation of Compressive Strength

In order to test the compressive strength, use was made of a Controls L-1301 double chamber apparatus conforming to standard EN196-1, and belonging to precision class 1, according to standard EN12390-4. The frame is made up of a two-column structure with a double test chamber mounted on a steel base. The piston and the cylinder are single-acting assemblies, provided with electric limit switches to limit the piston travel. The compression chamber is characterised by a maximum load of 250 kN and possesses cells with strain gauges (load cells) inserted between the upper cross member and the upper plate; the plates have a hardness of 600 HV. During the test, they are closed off by a transparent safety guard. The test samples used for the strength test are cube-shaped, with 40 mm sides. They are inserted into the specific test chamber, which consists of steel plates below the press, wherein we find a system that allows for the correct positioning thereof.

Before the measurement, the geometric characteristics of the test sample, test speed values and sensitivity it is intended to use are indicated in a specific software application. In this study the load is applied at a speed of 1200 N/s for measurements at all the set times. The test ends when the resistance of the sample against the press becomes almost zero: in this case the sample is brought to the breaking point and its maximum strength is recorded.

The breaking stress under compression, σ [N/mm2], is calculated with the following equation:

$$σ = \frac{F}{A}$$

Where F refers to the force applied by the press [N] and A to the base area of the test sample in contact with the plate of the press [mm2].

### Example 1

Regulatory Capacity of Potassium Sulphate with Respect to Ettringite Formation in Conglomerates Obtained with a Composition According to the Invention.

Two binding compositions according to the invention were prepared, the only difference being whether potassium sulphate was present or not, in order to demonstrate the capacity of this compound to control ettringite formation by favouring the formation of primary ettringite and inhibiting the formation of secondary ettringite.

For each of the two binding compositions, 5 test samples of 50 g each were produced; 300 g of material were weighed to produce them.

### Pure Past Samples for XRD/TGA Analysis:

| % w/w | REFERENCE 1 | FORMULA 1 |
|---|---|---|
| Ladle slag | 75 | 72.75 |
| Anhydrite | 25 | 24.25 |
| K₂SO₄ | \ | 3 |
| Water/binder ratio | 0.6 | 0.5 |
| Slag Blaine value | 3,600 | 3,600 |
| (cm²/g) | | |

Once weighed, the two compositions were mixed in order to homogenise the powders within them.

For the production of the test samples, water was added and an electric mixer was used, care being taken to mix the powder and water for at least 2 minutes.

The mixture was then poured into small plastic containers. Finally, the test samples were allowed to cure in a climate chamber with 60% humidity and a temperature of 21° C.

The test samples of the first composition were obtained by mixing the composition with water, in a water/composition ratio of 0.6.

The test samples of the second composition were obtained by mixing the composition with water, in a water/cement ratio of 0.5.

Water at 4° C. was used to obtain the test samples.

XRD mineralogical analysis, with corundum as the standard, was performed 6 hours, 24 hours, 48 hours, 7 days, and 28 days after mixing with water in order to quantify the crystalline phases and amorphous component within the test samples. The % of the amorphous component refers to everything within the test sample that does not possess an organised structure like that of a crystal, it does not necessarily refer to the initial amorphous calcium aluminate.

The periclase, dolomite and quartz phases are present in the ladle slag reagent. The calcite, syngenite, monosulphate and portlandite phases develop after hydration of the compositions.

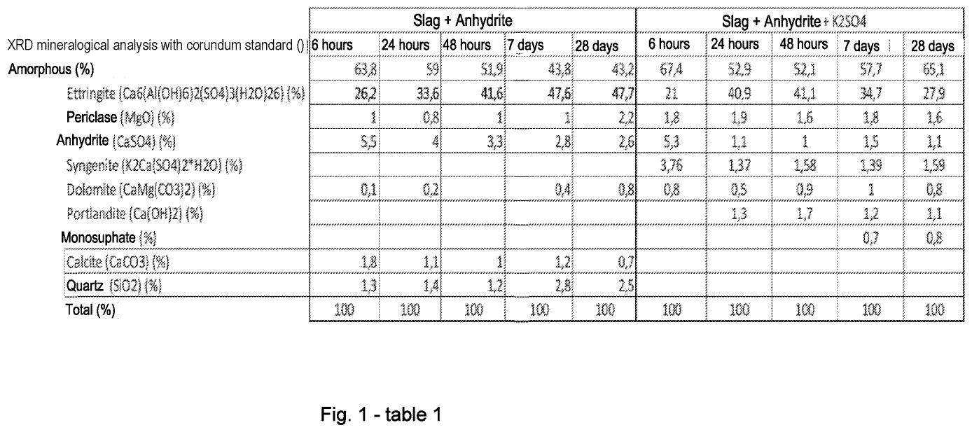

With reference to table 1 in FIG. 1, in the row regarding ettringite, it can be observed that in the conglomerate obtained from the composition without potassium sulphate, ettringite formation continues over time, though the largest part of growth is observed in the first hours. In the conglomerate obtained from the composition to which potassium sulphate was added, by contrast, it can be observed that ettringite formation increases in the first 24 hours and then decreases.

As further support of this analysis, it may be considered that the percentage of anhydrite, i.e. of calcium sulphate used as a reagent for ettringite formation, varies in table 1 in FIG. 1: in the system without potassium sulphate, the anhydrite remains in greater percentages even after long periods compared to the system to which potassium sulphate was added. In fact, after 28 days the percentage value of anhydrite is 2.6% in the system without potassium sulphate, versus a percentage value of anhydrite of 1.1% in the system with potassium sulphate. Therefore, the reactivity of the first system without potassium sulphate is lower and poorly regulated compared to the reactivity of the second system, which sees less of it at 28 days.

### Example 2

### Analysis of Compressive Strength

The addition of potassium sulphate leads to an increase in the ettringite produced in the first hours, as indicated in example 1 described above. Furthermore, the addition of potassium sulphate leads to an increase in mechanical strength (CS) and a decrease in the curing time.

Binding compositions according to the invention were prepared with 70% of an inert phase (standard sand) and 30% of a binding phase, thus composed:

| | REFERENCE | FORMULA | FORMULA | FORMULA |
|---|---|---|---|---|
| % w/w | 1 | 2 | 3 | 4 |
| Ladle | 75 | 73.72 | 72.97 | 72.52 |
| slag | | | | |
| Anhydrite | 25 | 24.58 | 24.33 | 24.18 |
| K₂SO₄ | \ | 1.7 | 2.7 | 3.3 |

Water at 4° C. was used to obtain the test samples.

TABLE 2
binding composition with different amounts of
potassium sulphate

| | 0% | 1.7% | 2.7% | 3.3% |
|---|---|---|---|---|
| | K₂SO₄ | K₂SO₄ | K₂SO₄ | K₂SO₄ |
| Water/binder | 0.6 | 0.5 | 0.5 | 0.5 |
| ratio | | | | |
| Slag Blaine | 4,500 | 4,500 | 4,500 | 4,500 |
| value | | | | |
| (cm²/g) | | | | |
| Curing time | 180 | 90 | 70 | 40 |
| (min) | | | | |
| CS at 6 h | \ | 12 | 18 | 20 |
| (MPa) | | | | |
| CS at 24 h | 10 | 23 | 24 | 24 |
| (MPa) | | | | |
| CS at 7 days | 17.6 | 26 | 28 | 29 |
| (MPa) | | | | |

### Example 3

### Comparative Example of the CS of Compositions Containing the BOF According to Application WO2022238376 and Compositions Containing the Ladle Slag Used in the Present Invention.

The compressive strength (CS) of a composition containing the BOF according to international application WO2022238376, in particular composition 1 on page 29, was compared with the composition containing the ladle slag used in the present invention.

As may be noted from table 3 below, the use of ladle slag as opposed to BOF allows greater mechanical strengths to be obtained, the amount of time being equal.

Among other things, this occurs with a higher mix ratio for ladle slag compared to BOF: usually, as is known from the specialised literature, as the mix ratio increases, there is also a decrease in mechanical strength, something that does not occur when ladle slag is used.

TABLE 3
comparison of CS of composition 1 of WO2022238376
and of a composition containing the ladle slag used in the
present invention at 7 days.

| | Composition no. 1 | Ladle slag-based |
|---|---|---|
| | of WO2022238376 | composition |
| | (weight in g) | (% by weight) |
| BOF | 100 | \ |
| Ladle slag | \ | 100 |
| H₂O/binder ratio | 0.29 | 0.6 |
| Blaine value (cm²/g) | Not known | 3,600 |
| CS at 7 days | 1.1 | 8.22 |
| (MPa) | | |

In the ladle slag-based composition, reference is made to 100% of binder, which must then be recalculated to 30% and introduced into the standard mortar for CS calculation.

Water at 4° C. was used to obtain the test samples.

The increase in mechanical strength in compositions containing the ladle slag used in the present invention compared with compositions that use the BOF according to WO2022238376 also takes place in the presence of calcium sulphate, as indicated in table 4 below. In this case as well, a higher mix ratio was used for the composition containing the ladle slag used in the present invention and higher CS values were obtained, contrary to what would be expected from the specialised literature.

TABLE 4
comparison of CS of composition 63 di WO2022238376 and
of a composition containing the ladle slag used in the present
invention at 1, 2 and 28 days.

| | Composition no. 63 | Ladle slag-based |
|---|---|---|
| | of WO2022238376 | composition |
| | (weight in grams) | (% by weight) |
| BOF | 96.8 | \ |
| Ladle slag | \ | 83.3 |
| CaSO₄ | 3.2 | 16.7 |
| H₂O/binder ratio | 0.29 | 0.6 |
| Blaine value (cm²/g) | not known | 3,600 |
| CS at 1 day (MPa) | not measured | 3.6 |
| CS at 2 days (MPa) | 0.7 | not measured |
| CS at 28 days (MPa) | 15.9 | 17.5 |

In the ladle slag-based composition, reference is made to 100% of binder, which must then be recalculated to 30% and introduced into the standard mortar for CS calculation.

Water at 4° C. was used to obtain the test samples.

### Example 4

### Comparative Example of the CS of Compositions Containing BOF or GGBS According to Application WO2022238376 and a Composition According to the Present Invention.

Table 5 shows the measurement over time of the compressive strength (CS) of a composition according to the invention.

TABLE 5

| | Composition of binding |
|---|---|
| | phase based on ladle |
| | slag (% by weight) |
| Ladle slag | 73.7 |
| Potassium | 3.3 |
| sulphate | |
| Tartaric acid | 0.50 |
| Anhydrite | 22.5 |
| H₂O/binder ratio | 0.42 |
| Slag Blaine value | 3,800 |
| (cm²/g) | |
| CS at day (MPa) | 53 |
| CS at 7 days (MPa) | 65.5 |
| CS at 28 days | 68 |
| (MPa) | |

In the ladle slag-based composition, reference is made to 100% of binder, which must then be recalculated to 30% and introduced into the standard mortar for CS calculation.

As may be verified in examples 2-51, 53-66 and 68-75 of application WO2022238376, none of the mechanical strength values of the composition according to the invention described here are reached, not even after a period of 28 days.

### Example 5

Demonstration of the Capacity of Tartaric Acid to Increase the Short-Term Mechanical Strength of Conglomerates Obtained with a Composition According to the Invention.

Binding compositions according to the invention were prepared with 70% of an inert phase (standard sand) and 30% of a binding phase, thus composed:

| | FORMULA | FORMULA | FORMULA | FORMULA |
|---|---|---|---|---|
| (% by weight) | 4 | 5 | 6 | 7 |
| Ladle slag | 72.52 | 72.4 | 72.27 | 72.15 |
| Anhydrite | 24.18 | 24.13 | 24.1 | 24.05 |
| K₂SO4 | 3.3 | 3.3 | 3.3 | 3.3 |
| Tartaric acid | \ | 0.17 | 0.33 | 0.5 |
| H₂O/binder | 0.5 | 0.45 | 0.42 | 0.42 |
| ratio | | | | |

Water at 4° C. was used to obtain the test samples of formula 4; water at room temperature was used for the other test samples.

For the production of the test samples, water was added and an automatic mixer was used. Then the mixture was poured into 4×4×4 cm cube-shaped moulds and compacted. Finally, the test samples were cured according to standard UNI EN 12190, PCC conditioning, for 24 h, 7 days and 28 days. Increasing percentages of tartaric acid were used in the compositions to demonstrate that with increases in said percentage the setting time increases, but the mechanical compressive strength at 24 hours also increases, something that does not occur in conventional systems.

Normally, an increase in the setting time corresponds to a decrease in mechanical performance.

TABLE 6

| | % by weight of tartaric acid | | | |
|---|---|---|---|---|
| | 0 | 0.17 | 0.33 | 0.5 |
| Slag Blaine | 4,500 | 4,500 | 4,500 | 4,500 |
| value (cm²/g) | | | | |
| Setting time | 40 (*) | 10 | 20 | 40 |
| (minutes) | | | | |
| Compressive | 24 | 31 | 32 | 42 |
| strength at 24 | | | | |
| hours (MPa) | | | | |

(*) not comparable given the use of cold water unlike for the other samples

TABLE 7

| | % by weight of tartaric acid | |
|---|---|---|
| | 0.33 | 0.5 |
| Slag Blaine | 3000 | 3000 |
| value (cm²/g) | | |
| Setting time | 38 | 70 |
| (minutes) | | |
| Compressive | 9 | 14 |
| strength at 24 | | |
| hours (MPa) | | |
| Compressive | 17.7 | 23.8 |
| strength at 7 | | |
| days (MPa) | | |

### Example 6

### Demonstration of the Capacity of Tartaric Acid to Accelerate the Formation of Primary Ettringite.

Two binding compositions according to the invention were prepared, with the only difference being the presence or absence of tartaric acid to demonstrate the capacity of this compound to accelerate the formation of primary ettringite.

For the production of five 50 g test samples, 300 g of material were weighed for each of the two compositions.

Pure paste samples for XRD analysis without the inert phase:

| (% by weight) | FORMULA 4 | FORMULA 7 |
|---|---|---|
| Ladle slag | 72.52 | 72.15 |
| Anhydrite | 24.18 | 24.05 |
| K2SO4 | 3.3 | 3.3 |
| Tartaric acid | \ | 0.5 |
| H₂O/binder ratio | 0.5 | 0.42 |

Once weighed, the two compositions were mixed in order to homogenise the powders within them.

For the production of the test samples, water was added and an electric mixer was used, with care being taken to mix the powder and water for at least 2 minutes.

Then the mixture was poured into small plastic containers. Finally, the test samples were allowed to cure in a climate chamber with 60% humidity and a temperature of 21° C.

Water at 4° C. was used to obtain the test samples of formula 4, whereas water at room temperature was used to obtain the test samples of formula 7.

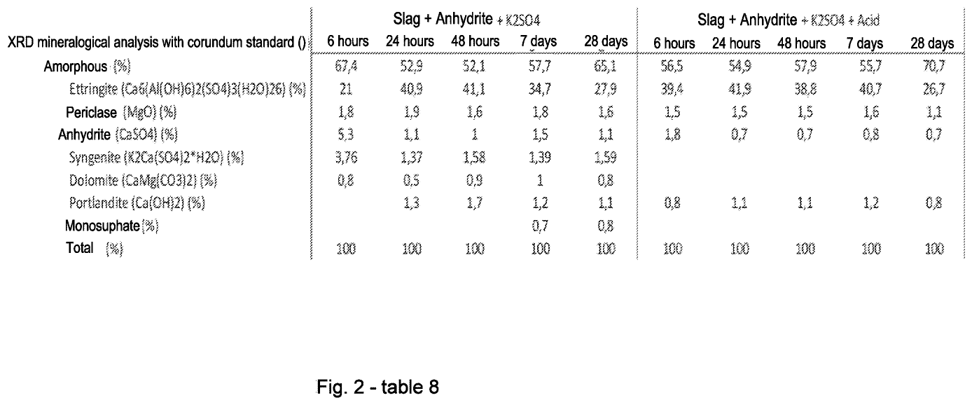

In the first composition ladle slag (referred to simply as slag in table 8 in FIG. 2), anhydrite and potassium sulphate were mixed, and then water was added.

In the second composition ladle slag (referred to simply as slag in table 8 in FIG. 2), anhydrite, potassium sulphate and tartaric acid in a percentage amount of 0.5% by weight of the total weight of the composition (referred to simply as “acid” in table 8 in FIG. 2) were mixed, and then water was added.

The presence of tartaric acid in the binding composition of the invention brings about a more rapid formation of primary ettringite: as can be seen in table 8 in FIG. 2, in fact, after 6 hours one observes a higher percentage consumption of the reagents, ladle slag and anhydrite, to form the product ettringite in the presence of tartaric acid, compared to the consumption of these reagents observed in the absence of tartaric acid. Consequently, the percentage amount of primary ettringite formed through the reaction between the calcium aluminate of the ladle slag and anhydrite is greater when tartaric acid is present in the binding composition.

### Example 7

### Demonstration of the Hardening Accelerating Action of the Carboxylic Acids in Compositions According to the Invention.

The curing time being equal, the use of a carboxylic acid with at least two carboxyl groups in the compositions according to the invention, F1, F2, F3, F4 and F5, increases the mechanical strength and degree of hydration of the binding system. Moreover, an effect as setting accelerants is also shown.

In table 9 below one may distinctly observe the increases in the setting time and compressive strength.

Binding compositions according to the invention were prepared with 70% of an inert phase (standard sand) and 30% of a binding phase, thus composed (table 9):

TABLE 9
increases in setting time and compressive strength (CS) of seven compositions according to the invention.

| | FORMULA | FORMULA | FORMULA | FORMULA | FORMULA | FORMULA | FORMULA |
|---|---|---|---|---|---|---|---|
| | 4 | 5 | 6 | 7 | 8 | 9 | 10 |
| Slag | 72.52 | 72.4 | 72.27 | 72.15 | 72.4 | 72.27 | 72.15 |
| Anhydrite | 24.18 | 24.13 | 24.1 | 24.05 | 24.13 | 24.1 | 24.05 |
| Potassium | 3.3 | 3.3 | 3.3 | 3.3 | 3.3 | 3.3 | 3.3 |
| sulphate | | | | | | | |
| Citric | | | | | 0.17 | 0.33 | 0.5 |
| acid | | | | | | | |
| Tartaric | | 0.17 | 0.33 | 0.5 | | | |
| acid | | | | | | | |
| Slag | 4,500 | 4,500 | 4,500 | 4,500 | 4,500 | 4,500 | 4,500 |
| Blaine | | | | | | | |
| value | | | | | | | |
| (cm²/g) | | | | | | | |
| H₂O/binder | 0.5 | 0.45 | 0.42 | 0.42 | 0.45 | 0.42 | 0.42 |
| ratio | | | | | | | |
| Setting | 40 (*) | 10 | 20 | 40 | 2 | 7 | 10 |
| time | | | | | | | |
| CS at 24 | 24 | 31 | 32 | 42 | 31.4 | 34.5 | 38.5 |
| hours | | | | | | | |
| (MPa) | | | | | | | |

(*) not comparable given the use of cold water unlike for the other samples Water at 4° C. was used to obtain the test samples of formula 4; water at room temperature was used for the others.

### Example 8

Comparative Example: Composition with a % Amount by Weight of Carboxylic Acid Greater than the Range of Percentages of Carboxylic Acid Present in the Compositions According to the Invention.

Binding compositions according to the invention were prepared with 70% of an inert phase (standard sand) and 30% of a binding phase, thus composed:

| (% by | FORMULA | FORMULA | FORMULA | FORMULA |
|---|---|---|---|---|
| weight) | 5 | 6 | 7 | 11 |
| Ladle slag | 72.4 | 72.27 | 72.15 | 70.05 |
| Anhydrite | 24.13 | 24.1 | 24.05 | 23.35 |
| Potassium | 3.3 | 3.3 | 3.3 | 3.3 |
| sulphate | | | | |
| Tartaric | 0.17 | 0.33 | 0.5 | 3.3 |
| acid | | | | |
| H₂O/binder | 0.45 | 0.42 | 0.42 | 0.42 |
| ratio | | | | |

For the production of the test samples, water at room temperature was added and an automatic mixer was used. Then the mixture was poured into 4×4×4 cm cube-shaped moulds and compacted. Finally, the test samples were cured according to standard UNI EN 12190, PCC conditioning, for 24 h, 7 days and 28 days.

Table 10 below shows the test results compared with the results of the experimental test carried out in example 5.

TABLE 10
experimental results at different percentages of tartaric acid,
both according to the invention, and at a percentage greater
than the range of carboxylic acid according to the invention.

| | % by weight of tartaric acid | | | |
|---|---|---|---|---|
| | 0.17 | 0.33 | 0.5 | 3.3 |
| Slag Blaine | 4,500 | 4,500 | 4,500 | 4,500 |
| value (cm²/g) | | | | |
| Setting time | 10 | 20 | 40 | Greater |
| (minutes) | | | | than 240 |
| Compressive | 31 | 32 | 42 | 1, 4 |
| strength 24 | | | | |
| hours (MPa) | | | | |

Based on the measured strengths at concentrations higher than those of the compositions according to the invention, tartaric acid is a retardant, both of setting and hardening, as known from the literature.

### Example 9

Regulatory Capacity of Soluble Sulphate with Respect to Ettringite Formation in Conglomerates Obtained with Compositions According to the Invention.

In order to demonstrate the capacity of soluble sulphates to control ettringite formation, favouring the formation of primary ettringite and inhibiting the formation of secondary ettringite, five binding compositions according to the invention were prepared, each containing the same percentages of ladle slag, anhydrite and a soluble sulphate, but differing from one another in relation to the specific soluble sulphate used: potassium sulphate, lithium sulphate, sodium sulphate, magnesium sulphate or aluminium sulphate (table 11).

The five compositions were compared with an analogous binding composition not containing the soluble sulphate.

The same batches of basic raw materials, ladle slag and anhydrite were used for all the compositions.

Pure paste samples were prepared for XRD analysis without the inert phase.

TABLE 11
compositions used

| | | Composition |
|---|---|---|
| | | with addition |
| | | of soluble |
| | Reference 1 | sulphate |
| Raw materials | % | % |
| Ladle slag | 75.0 | 72.5 |
| Anhydrite | 25.0 | 24.18 |
| Soluble sulphate | | 3.3 |
| (K₂SO4, Na₂SO₄, | | |
| LiSO₄, MgSO4, AISO₄) | | |
| Slag Blaine value | 3,800 | 3,800 |
| (cm²/g) | | |
| H2O/binder ratio | 0.6 | 0.5 |

For each of the binding compositions, 5 test samples of 50 g each were produced; 300 g of material were weighed to produce them. Once weighed, the compositions were mixed in order to homogenise the powders within them. For the production of the test samples, water was added and an electric mixer was used, care being taken to evenly mix the powder and water.

The mixture was then poured into small plastic containers. Finally, the test samples were allowed to cure in a climate chamber with 60% humidity and a temperature of 21° C.

Water at 4° C. was used to obtain the test samples.

XRD mineralogical analysis was performed, with corundum as the standard, 6 hours, 24 hours, 7 days and 28 days after mixing with water in order to quantify the crystalline and amorphous phases within the test
samples.

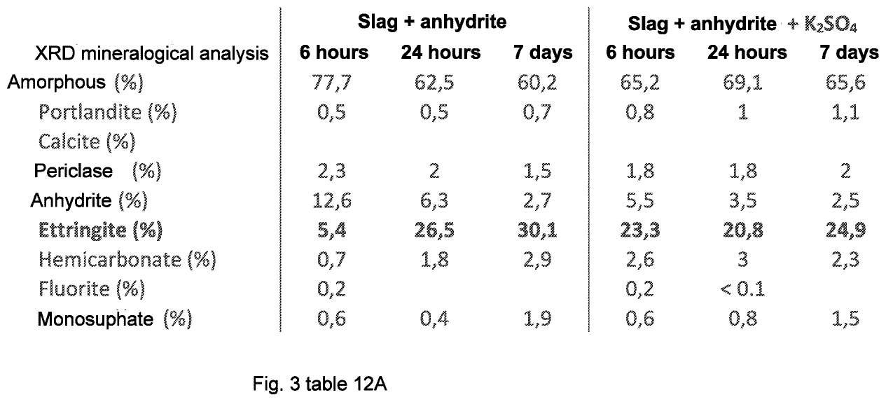

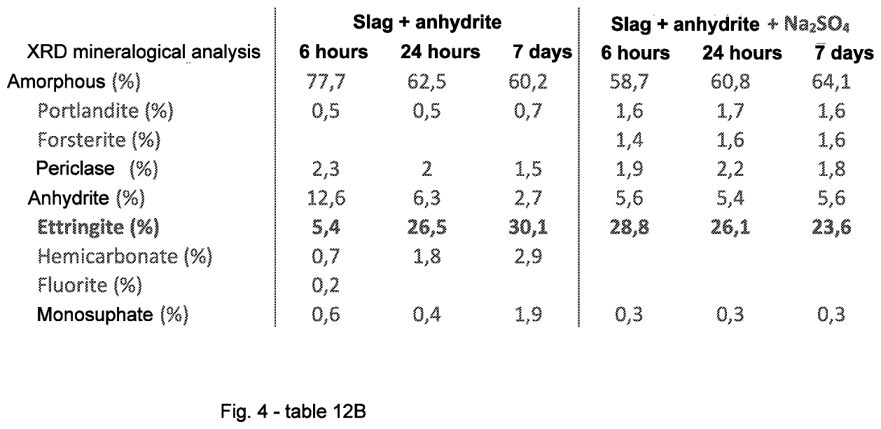

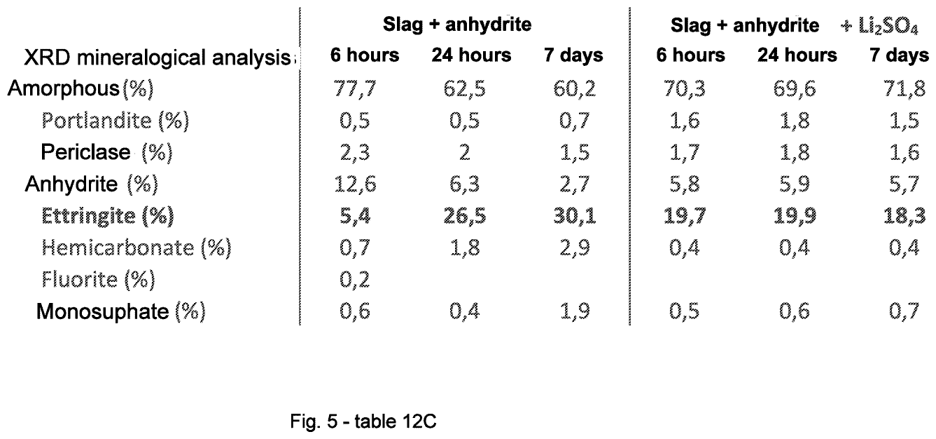

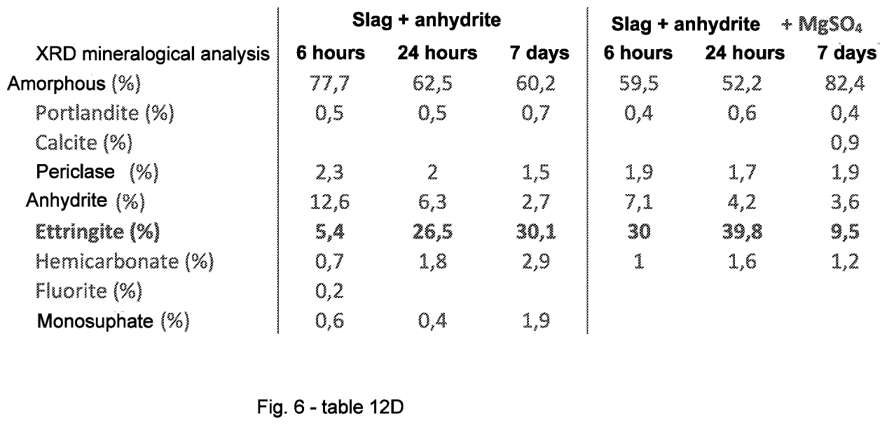

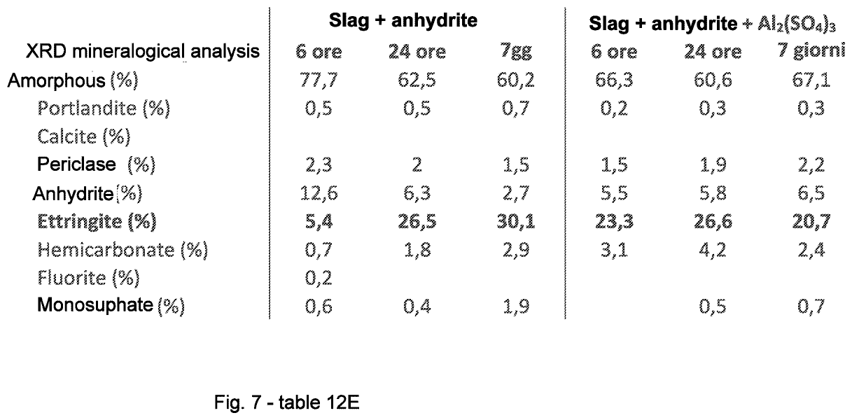

As may be observed from the results in tables 12A (potassium sulphate), 12B (sodium sulphate), 12C (lithium sulphate), 12D (magnesium sulphate) and 12E (aluminium sulphate), shown respectively in FIGS. 3, 4, 5, 6 and 7, the soluble sulphates regulate the production of ettringite, causing it to increase mainly in the first hours of the reaction, when the plastic phase of the test sample enables the formation thereof without stress on the mineral. Afterwards, the percentage of ettringite remains nearly constant or decreases, thus preventing the appearance of secondary ettringite in the long term.

### Example 10

Demonstration of the Capacity of Carboxylic Acids with at Least Two Carboxyl Groups to Retard the Setting Time and Increase the Short-Term Mechanical Strength of Conglomerates Obtained with a Composition According to the Invention.

In order to demonstrate the capacity of carboxylic acids with at least two carboxyl groups to retard the setting time and increase the short-term mechanical strength of conglomerates obtained with a composition according to the invention, three binding compositions according to the invention were prepared, each containing the same percentages of ladle slag, anhydrite and potassium sulphate, ma differing from each other in relation to the specific carboxylic acid used: tartaric acid, citric acid and malic acid (table 13).

Pure paste samples were prepared for XRD analysis and binding compositions according to the invention were prepared with 70% of an inert phase (standard sand) and 30% of a binding phase, thus composed for mechanical strengths:

TABLE 13
compositions used

| | | Composition |
|---|---|---|
| | | with the |
| | | addition of |
| | | carboxylic |
| | Formula 4 | acid |
| Raw materials | % | % |
| Ladle slag | 72.52 | 73.8 |
| Anhydrite | 24.18 | 22.4 |
| Potassium sulphate | 3.3 | 3.3 |
| Carboxylic acid | | 0.5 |
| (tartaric acid. citric | | |
| acid, malic acid) | | |
| Slag Blaine value | 3,800 | 3,800 |
| (cm²/g) | | |
| H2O/binder ratio | 0.5 | 0.4 |

For each of the binding compositions, 5 test samples of 50 g each were produced; 300 g of material were weighed to produce them.

Once weighed, the compositions were mixed in order to homogenise the powders within them. For the production of the test samples, water was added and an electric mixer was used, care being taken to evenly mix the powder and water.

The mixture was then poured into small plastic containers. Finally, the test samples were allowed to cure in a climate chamber with 60% humidity and a temperature of 21° C.

To obtain the test samples, water at 4° C. was used for formula 4, whereas water at room temperature was used for those to which acid was added.

XRD mineralogical analyses were performed, with corundum as the standard, and a thermogravimetric analysis (TGA) was performed 6 hours, 24 hours, 7 days, and 28 days after mixing with water in order to quantify the crystalline and amorphous phases and degree of hydration of the test samples.

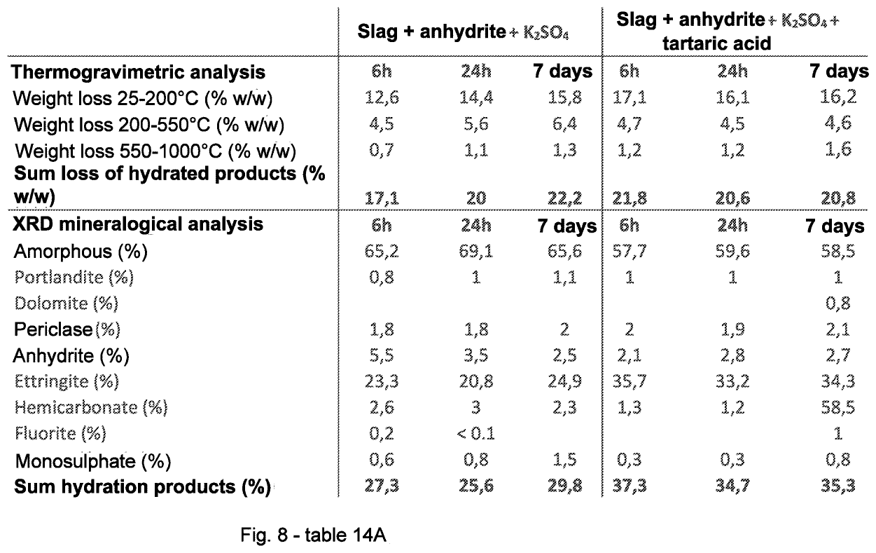

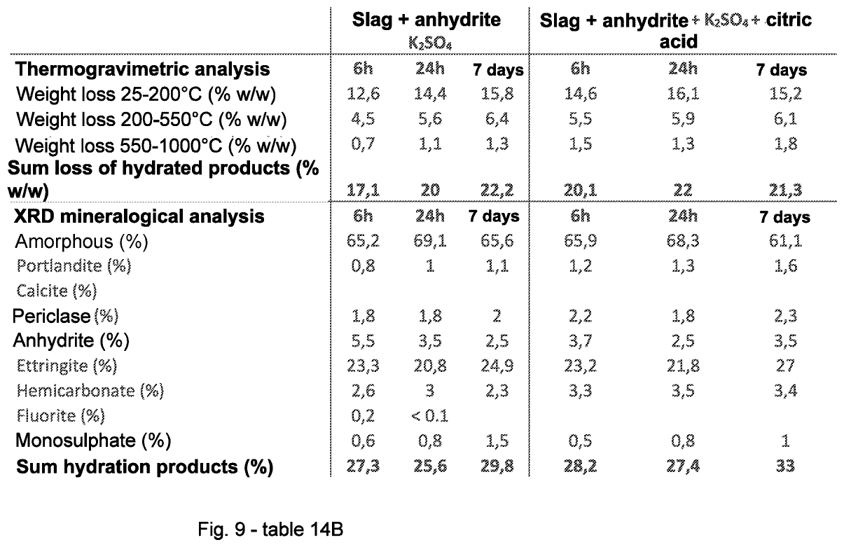

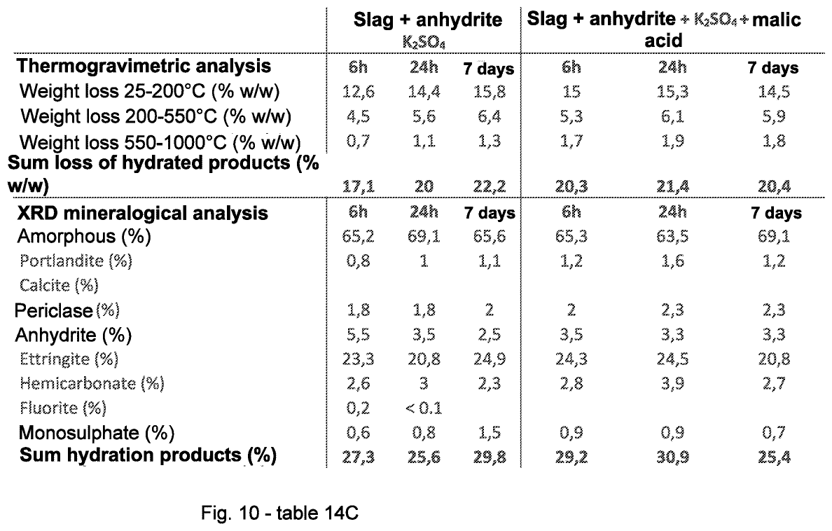

As may be observed from the results in tables 14A (tartaric acid), 14B (citric acid) and 14C (malic acid), shown respectively in FIGS. 8, 9 and 10, the carboxylic acids with at least two carboxyl groups delay the setting time of the systems and at the same time they enhance the mechanical performance of the latter, above all in the short term. The carboxylic acids with at least two carboxyl groups behave as setting retardants, but they simultaneously also behave as hardening accelerants.

In order to analyse this accelerating action of carboxylic acids with at least two carboxyl groups, a thermogravimetric analysis was also performed to support the mineralogical analysis: in this manner, one can better evaluate the contribution of the test sample to reactivity by adding carboxylic acid. In fact, the hydration of a system is due not only to the production of crystalline minerals, but also to hydrated amorphous or scarcely crystalline structures that are not detected by XRD. In order to identify a w/w % amount (percentage by weight) of a hydrated test sample, TGA analyses were carried out in which the water weight loss is measured in relation to increases in temperature.

The temperature ranges known as ranges of loss of possible reaction products, both amorphous and crystalline, are:
weight loss at 25-200° C. (% w/w): all sulphated and aluminate hydrate systems,
weight loss at 200-550° C. (% w/w): portlandite and amorphous gels, both aluminate and silicate.

By then analysing the data obtained, one may identify the addition of tartaric acid as the preferred situation, but a similar action, albeit of a lower intensity, is also observed with the addition of malic or citric acid. In the short term, i.e. at 6 h and 24 h, all the test samples containing carboxylic acid show a percentage of hydration products and a greater weight loss associated with hydration compared to the system that does not have the additive under analysis.

From 7 days onwards, the trend is more variable, but less important for functional purposes, since the dense, compact structure was formed in the first hours of hydration.

In order to evaluate the mechanical strength data at 24 h of the reference tests and those with 0.15% of the different carboxylic acids, compositions according to the invention were prepared with 70% of an inert phase (standard sand) and 30% of a binding phase. The reference composition has a binding phase composed of 21.8% ladle slag, 7.2% anhydrite and 1% K₂SO₄, whereas the binding phases of the test samples analysed are composed of 21.64% ladle slag, 7.21% anhydrite, 1% K₂SO₄ and 0.15% carboxylic acid.

For the production of the test samples, cold water at 4° C. was added and an automatic mixer was used.

All formulations show a mix ratio of 13% H₂O with respect to the total formula (inert+binder). Then the mixture was poured into 4×4×4 cm cube-shaped moulds and compacted. Finally, the test samples were cured according to standard UNI EN 12190, PCC conditioning, for 24 hours.

The results are shown in table 15 below.

TABLE 15

| | | Tartaric | Citric | Malic |
|---|---|---|---|---|
| Composition | Reference | acid | acid | acid |
| Mechanical | 32.2 | 53.2 | 45.6 | 45.1 |
| strength (CS) | | | | |
| at 24 h (MPa) | | | | |

### Example 11

Example of a Cement with the Addition of a Composition According to the Invention.

An evaluation was made of the mechanical strength (CS) at 24 h of a CEM I 52.5 R cement to which a binding composition of the invention with the following formula was added:

| Binding composition | |
|---|---|
| (additive) | % |
| Ladle slag con Blaine value | 72.7 |
| of 3,800 | |
| Anhydrite | 19.5 |
| Potassium sulphate | 6.6 |
| Tartaric acid | 1.2 |

| Formula (with | | | Cement | |
|---|---|---|---|---|
| reference only to the | | | with | |
| binder part) (%) | Reference | | additive | |
| CEM I 52.5 R | 100 | | 60 | |
| Binder (additive) | — | | 40 | |
| Water/binder ratio | 0.5 | | 0.45 | |
| Setting time | 6 | hours | 35 | minutes |
| CS at 24 h | 28 | MPa | 36 | MPa |

The CS of a CEM I 52.5 R cement at 24 h improves in the presence of a composition according to the invention.

1. Composition comprising ladle slag, calcium sulphate, at least one soluble sulphate having a solubility in water at 20° C. in the range of 5 g/100 mL to 90 g/100 mL and at least one carboxylic acid that has at least two carboxyl groups, wherein the percentage by weight of the at least one soluble sulphate is between 0.3 and 10% relative to the total weight of the composition, the percentage ratio between calcium sulphate and ladle slag ranges between 1:2 and 1:6, and wherein the carboxylic acid is present in an amount of between 0.05% and 3% by weight relative to the total weight of the composition.

2. Composition according to claim 1, wherein the ladle slag has Blaine fineness values of between 2,000 and 11,000 cm²/g.

3. Composition according to claim 1, wherein the percentage by weight of ladle slag is between 37% and 84.65% relative to the total weight of the composition.

4. Composition according to claim 1, wherein the percentage by weight of calcium sulphate is between 15% and 50% relative to the total weight of the composition.

5. Composition according to claim 1, wherein the percentage by weight of the at least one soluble sulphate is between 2.7 and 3.5% relative to the total weight of the composition.

6. Composition according to claim 1, wherein the calcium sulphate is selected from anhydrous calcium sulphate, calcium sulphate dihydrate and calcium sulphate hemihydrate.

7. Composition according to claim 1, wherein the at least one soluble sulphate is selected from an alkaline sulphate, an alkaline earth sulphate and aluminium sulphate, with the exception of radioactive alkaline or alkaline earth sulphates.

8. Composition according to claim 1, wherein the at least dicarboxylic acid has a hydroxyl group in the α position relative to the carboxyl group and wherein the carboxylic acid is selected from tartaric acid, malic acid, citric acid, lactic acid, succinic acid, oxalic acid and/or malonic acid.

9. (canceled)

10. Premixed cement-based product comprising the composition according to claim 1 and aggregates, said aggregates being selected in the group consisting of: stones, artificial aggregates, sand, endogenous rocks, exogenous rocks, expanded clay, glass, or a combination thereof, said premixed cement-based product being a premixed cement-based product in dry form to be hydrated.

11. Premixed cement-based product obtained by mixing the composition according to claim 1 with water and aggregates, said aggregates being selected in the group consisting of: stones, artificial aggregates, sand, endogenous rocks, exogenous rocks, expanded clay, glass, and a combination thereof.

12. Cement-based conglomerate made with the premixed cement-based product according to claim 10.

13. Cement comprising the composition according to claim 1.

14. Cement according to claim 13, wherein the composition is present in a percentage amount in the range of 5% to 50%.

15. (canceled)

16. The composition according to claim 1, wherein the percentage ratio between calcium sulphate and ladle slag ranges between 1:3 and 1:4, and wherein the carboxylic acid is present in an amount of between 0.17% and 1.5% by weight relative to the total weight of the composition.

17. Composition according to claim 2, wherein the ladle slag has Blaine fineness values of between 3,000 and 6,000 cm²/g.

18. Composition according to claim 3, wherein the percentage by weight of ladle slag is between 71 and 75% relative to the total weight of the composition.

19. Composition according to claim 4, wherein the percentage by weight of calcium sulphate is between 22% and 24% relative to the total weight of the composition.

20. Composition according to claim 6, wherein the calcium sulphate is anhydrous calcium sulphate.

21. Composition according to claim 7, wherein the at least one soluble sulphate is selected from potassium sulphate, sodium sulphate, lithium sulphate, magnesium sulphate, and aluminium sulphate.

22. Cement according to claim 14, wherein the composition is present in a percentage amount in the range of 25% to 45%.
